(19) United States
(12) Patent Application Publication
(10) Pub. No.: US 2026/0110260 A1
(43) Pub. Date: Apr. 23, 2026

(54) COOLING SYSTEM FOR ELECTRIC TRACTOR

(71) Applicant: Korens Global Co., Ltd., Yangsan-si (KR)

(72) Inventors: Young Shin CHU, Busan (KR); Do Gyu KIM, Busan (KR); Jung Hoon PARK, Yangsan-si (KR)

(73) Assignee: Korens Global Co., Ltd., Yangsan-si (KR)

(21) Appl. No.: 19/353,493

(22) Filed: Oct. 8, 2025

(30) Foreign Application Priority Data
Oct. 18, 2024 (KR) 10-2024-0143346

(51) Int. Cl. F01P 7/16; B60K 11/02; F01P 3/18

(52) U.S. Cl. CPC F01P 7/165; B60K 11/02; F01P 3/18; F01P 2003/182

(57) ABSTRACT

A cooling system including a drive unit having a drive motor for generating drive power and a power take off motor for generating working power; a battery unit configured to supply power to the drive unit; a drive cooling unit configured to circulate a first cooling water to the drive unit to the drive unit to cool the same; a battery cooling unit configured to circulate a second cooling water to cool the battery unit; a bypass cooling unit disposed between the drive cooling unit and the battery cooling unit, the bypass cooling unit being configured to selectively exchange heat between the first cooling water and a heat exchange medium that exchanges heat with the second cooling water, and to supply the first cooling water to the drive unit; and a controller configured to control operations of the drive cooling unit, the battery cooling unit, and the bypass cooling unit.

### CROSS-REFERENCE TO RELATED APPLICATION

This application is based on and claims priority under 35 U.S.C. §119 to Korean Patent Application No. 10-2024-0143346, filed on October 18, 2024, in the Korean Intellectual Property Office, the disclosure of which is incorporated by reference herein in its entirety.

### BACKGROUND

### 1. Field

Embodiments of the present disclosure relate to a cooling system for an electric tractor.

### 2. Description of the Related Art

In general, along with the development and commercialization of electric vehicles, the electrification of agricultural machinery and agricultural transport equipment is also accelerating.

In particular, tractors are multi-purpose agricultural machines equipped with various peripheral devices, and their high utility has led to faster electrification compared to other agricultural machines, leading to an increase in the use of electric tractors.

An electric tractor may include a drive unit comprising a drive motor for transmitting power to the drive wheels and a power take off (PTO) motor for transmitting power to various types of work implements mounted on the tractor, and the drive motor and the PTO motor may be supplied with power from a battery unit.

Since the drive unit, including the drive motor and the PTO motor, generates heat during operation, the electric tractor may be equipped with a cooling system to optimally maintain the operating states of the drive motor and the PTO motor.

The cooling system of an electric tractor is an air-cooled system that uses a radiator to cool the cooling water with external air and supplies the cooled cooling water to the drive unit to form a cooling system.

However, conventional cooling systems of electric tractors have difficulty handling the high thermal loads generated under specific driving conditions, such as concentrated high-load conditions of the PTO motor, resulting in reduced cooling efficiency of the PTO motor under such specific operating conditions.

### SUMMARY

Embodiments of the present disclosure are intended to solve the above-mentioned problems and/or limitations, and an object of the present disclosure is to provide a cooling system for an electric tractor capable of improving the cooling efficiency of a PTO motor under specific operating conditions such as concentrated high loads with a simple structure.

In addition, embodiments of the present disclosure aim to provide a cooling system for an electric tractor that can efficiently control the operation of the cooling system to reduce the load of the cooling system and quickly cool the heat management target such as the drive unit and battery to improve the durability and performance of the heat management target.

However, these tasks are exemplary and the scope of the present disclosure is not limited thereby.

An embodiment of the present disclosure provides a cooling system for an electric tractor, comprising: a drive unit including a drive motor that generates drive power and a power take off (PTO) motor that generates work power; a battery unit that supplies power to the drive unit; a drive cooling unit that circulates a first cooling water to the drive unit and cools it; a battery cooling unit that circulates a second cooling water to the battery unit and cools it; a bypass cooling unit that is disposed between the drive cooling unit and the battery cooling unit and selectively heat-exchanges a heat exchange medium that exchanges heat with the second cooling water with the first cooling water and supplies the heat-exchanged medium to the drive unit; and a control unit that controls the operation of the drive cooling unit, the battery cooling unit, and the bypass cooling unit.

In an embodiment of the present disclosure, the drive cooling unit may include a first heat exchanger that exchanges heat with external air and supplies the first cooling water to the drive unit.

In an embodiment of the present disclosure, the drive cooling unit may further include a drive-side control valve that supplies the first cooling water heat-exchanged in the first heat exchanger to at least one of the drive motor and the PTO motor.

In an embodiment of the present disclosure, the battery cooling unit may include a second heat exchanger that supplies the second cooling water to the battery unit by exchanging heat with the heat exchange medium.

In an embodiment of the present disclosure, the second heat exchanger may include an evaporator that constitutes a refrigeration cycle of the heat exchange medium.

In an embodiment of the present disclosure, the bypass cooling unit may include a bypass heat exchanger that heat-exchanges the first cooling water supplied to the PTO motor and the heat exchange medium.

In an embodiment of the present disclosure, the bypass heat exchanger may be configured to receive a heat exchange medium from an evaporator constituting a refrigeration cycle of the heat exchange medium and to exchange heat between the received heat exchange medium and the first cooling water, and to supply the heat-exchanged heat exchange medium to a compressor constituting the refrigeration cycle.

In an embodiment of the present disclosure, the bypass cooling unit may further include a bypass control valve that selectively supplies the heat exchange medium from the evaporator to the bypass heat exchanger.

In an embodiment of the present disclosure, in case that the first cooling water is supplied only to the PTO motor by exchanging heat with the heat exchange medium through the bypass cooling unit, the first cooling water may be supplied to the bypass cooling unit by bypassing the section where heat is exchanged with external air.

In an embodiment of the present disclosure, the control unit may control the operation of the bypass cooling unit according to the current value generated during the operation of the drive unit.

Other aspects, features and advantages other than those described above will become apparent from the following drawings, claims and detailed description of the disclosure.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic diagram illustrating a cooling system for an electric tractor according to a comparative embodiment of the present disclosure;

FIG. 2 is a block diagram illustrating a cooling system for an electric tractor according to an embodiment of the present disclosure;

FIG. 3 is a schematic diagram illustrating a cooling system for an electric tractor according to an embodiment of the present disclosure;

FIG. 4 is a flowchart illustrating the operation process of a cooling system for an electric tractor according to an embodiment of the present disclosure;

FIG. 5 is a schematic diagram illustrating a cooling system for an electric tractor according to an embodiment of the present disclosure during normal-load operation; and

FIG. 6 is a schematic diagram illustrating a cooling system for an electric tractor according to an embodiment of the present disclosure during concentrated high-load operation.

### DETAILED DESCRIPTION

Hereinafter, the following embodiments will be described in detail with reference to the attached drawings. When describing with reference to the drawings, identical or corresponding components are given the same drawing reference numerals, and redundant descriptions thereof will be omitted.

These embodiments described herein may be subject to various modifications. Specific embodiments are illustrated in the drawings and described in detail in the detailed description. The effects and features of the present embodiments and the methods for achieving them will become clear with reference to the contents described in detail below together with the drawings. However, the present embodiments are not limited to embodiments disclosed below and may be implemented in various forms.

In the drawings, parts unrelated to the description are omitted to clearly explain the present disclosure, and similar parts are designated by similar drawing reference numerals throughout the specification.

In embodiments below, the terms first, second, etc. are not used in a limiting sense, but are used for the purpose of distinguishing one component from another.

In embodiments below, singular expressions include plural expressions unless the context clearly indicates otherwise.

In embodiments below, terms such as “include” or “have” mean that a feature or component described in the specification exists, and do not exclude in advance the possibility that one or more other features or components may be added.

In embodiments below, when a part such as a unit, region, or component is said to be on or above another part, this includes not only the case where it is directly above the other part, but also the case where another unit, region, component, etc. is interposed in between.

In embodiments below, terms such as connect or combine do not necessarily mean a direct and/or fixed connection or combination of two members, unless the context clearly indicates otherwise, and do not exclude the presence of another member between the two members.

In the drawings, the sizes of components may be exaggerated or reduced for convenience of explanation. For example, the size and thickness of each component shown in the drawing are illustrated arbitrarily for convenience of explanation, so the following embodiments are not necessarily limited to what is shown.

Terms such as upper, top, lower and bottom used in this specification are only used to easily describe the relationship between each component shown in the drawings, and do not limit the direction in which each component is arranged.

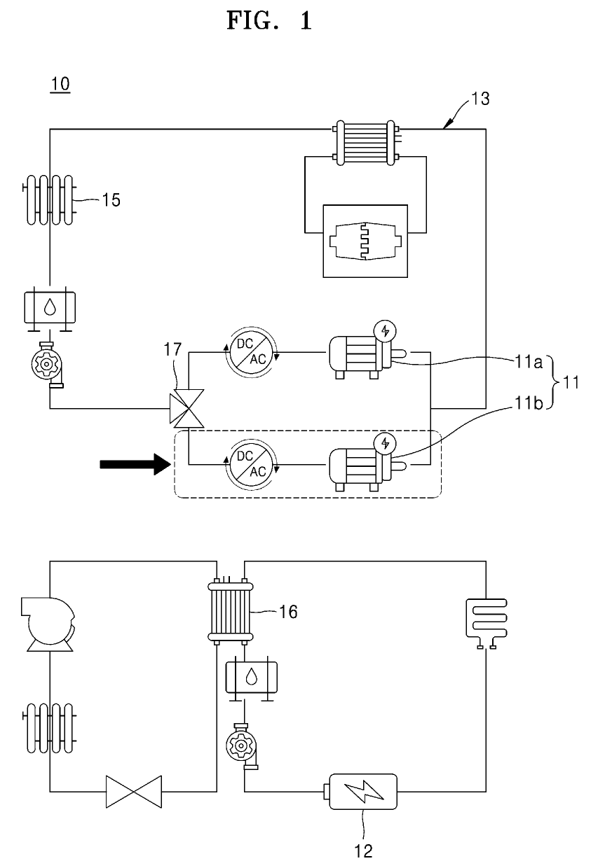

FIG. 1 is a schematic diagram for explaining a cooling system for an electric tractor according to a comparative embodiment of the present disclosure.

Referring to FIG. 1, the cooling system 10 for an electric tractor according to a comparative embodiment of the present disclosure may include a drive cooling unit 13 and a battery cooling unit 14 that are separated from each other for cooling the drive unit 11 and the battery unit 12.

The drive cooling unit 13 supplies cooling water cooled by air cooling through external air to the drive unit 11 to perform a cooling process and forms a cooling loop that circulates this cooling process.

At this time, the cooling water circulating through the drive cooling unit 13 may be cooled by external air through the radiator 15 and then supplied to the drive unit 11.

Specifically, the cooling water cooled through the radiator 15 may be branched by the control valve 17 and supplied to the drive motor 11a that generates drive power and the power take off (PTO) motor 11b that generates working power, respectively.

The cooling water that has cooled the drive motor 11a and the PTO motor 11b may be combined and circulated back to the radiator 15 through the cooling loop of the drive cooling unit 13.

The battery cooling unit 14 performs a cooling process by supplying cooling water cooled by water cooling through a refrigerant to the battery unit 12 and forms a kind of cooling loop that circulates this cooling process.

At this time, the cooling water circulating to the battery cooling unit 14 may be cooled as a refrigerant via the evaporator 16 and then supplied to the battery unit 12, and the evaporator 16 may receive the refrigerant through the refrigeration cycle of the refrigerant.

The cooling water that has cooled the battery unit 12 may be circulated back to the evaporator 16 through the cooling loop of the battery cooling unit 14.

However, the cooling system 10 for the electric tractor according to the comparative embodiment had a problem in that the cooling efficiency was low because it was difficult to handle the high-temperature heat load generated under specific operating conditions, such as concentrated high-load conditions of the PTO motor 11b, with the cooling water cooled by external air.

In some embodiments, the cooling system 10 for the electric tractor according to a comparative embodiment detected the coolant temperature of the drive unit 11 when the drive unit 11 was in operation, and operated the drive cooling unit 13 when the detected coolant temperature was equal to or higher than a preset temperature.

Accordingly, there was a problem in that the drive cooling unit 13 was operated after the actual time when cooling of the drive unit 11 was required, which increased the heat load of the drive unit 11 and reduced the cooling effect, thereby lowering the durability and performance of the drive unit 11.

The cooling system 100 for an electric tractor according to an embodiment of the present disclosure for solving the problems of the comparative embodiment described above is described as follows.

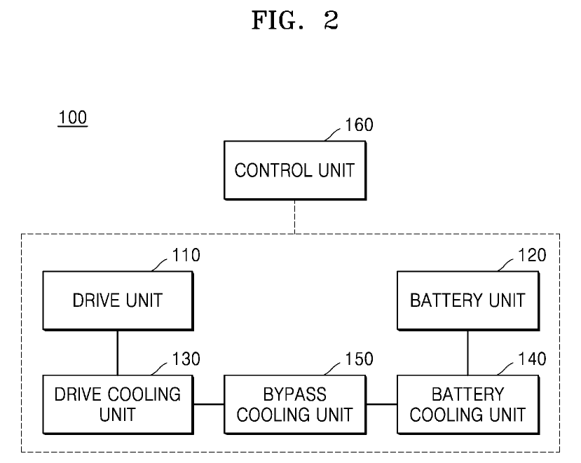

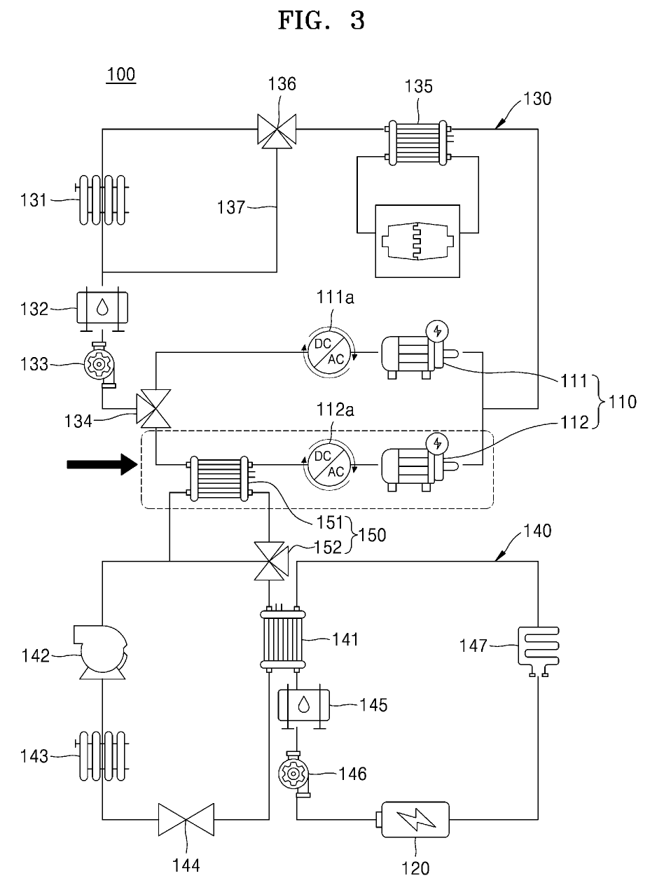

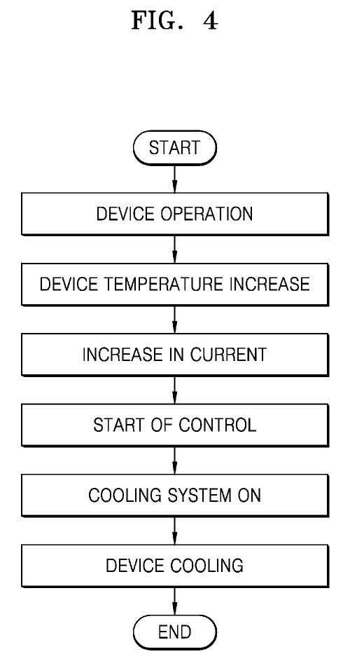

FIG. 2 is a block diagram illustrating a cooling system for an electric tractor according to an embodiment of the present disclosure, FIG. 3 is a configuration diagram illustrating a cooling system for an electric tractor according to an embodiment of the present disclosure, and FIG. 4 is a flowchart illustrating an operation process of a cooling system for an electric tractor according to an embodiment of the present disclosure.

Referring to FIGS. 2 to 4, the cooling system 100 for an electric tractor according to an embodiment of the present disclosure may improve the cooling efficiency of a drive unit 110 by supplying the first cooling water of the drive cooling unit 130 to the drive unit 110 by exchanging heat with the heat exchange medium of the battery cooling unit 140 under specific driving conditions such as concentrated high load of the drive unit 110.

In some embodiments, the cooling system 100 for an electric tractor according to an embodiment of the present disclosure may quickly respond to the heat load of a heat management target such as the drive unit 110 by operating the drive cooling unit 130 based on the current value generated when the drive unit 110 operates, thereby reducing the system load and increasing the durability and performance of the heat management target.

In more detail, the cooling system 100 for an electric tractor according to an embodiment of the present disclosure may include a drive unit 110, a battery unit 120, a drive cooling unit 130, a battery cooling unit 140, a bypass cooling unit 150, and a control unit 160.

The drive unit 110 may include a drive motor 111 that generates drive power for moving the electric tractor, and a power take off (PTO) motor 112 that generates working power for various types of work of the electric tractor.

The drive motor 111 and the PTO motor 112 may be electrically connected to the inverters 111a, 112a, respectively, and the inverters 111a, 112a may convert the AC power of the battery unit 120 into the DC power and supply the DC power to the drive motor 111 and the PTO motor 112, respectively.

The drive motor 111 and PTO motor 112 may be operated by receiving power from the inverters 111a, 112a and may generate a current value during operation.

In some embodiments, the current value generated during the operation of the drive motor 111 and the PTO motor 112 may increase in proportion to the increase in temperature of the drive motor 111 and the PTO motor 112.

Accordingly, the cooling system 100 for the electric tractor according to the present embodiment may accurately determine the temperature at which cooling of the drive motor 111 and the PTO motor 112 is required, and may set current values of the drive motor 111 and the PTO motor 112 corresponding to the temperature at which cooling is required.

Accordingly, the control unit 160 may detect the current value generated when the drive motor 111 and the PTO motor 112 operate, and may operate the drive cooling unit 130 when the detected current value is greater than a preset current value.

As described above, the cooling system 100 for the electric tractor according to the present embodiment is capable of performing cooling at the exact time when cooling of the drive unit 110 is required, thereby increasing cooling efficiency while reducing the load on the system, and thus improving the durability and performance of the drive unit 110.

The battery unit 120 may supply power to components that require electric energy, such as the drive unit 110, and may, for example, include a rechargeable lithium battery pack. The battery unit 120, together with the drive unit 110, may serve as a primary heat management target and be cooled via the battery cooling unit 140.

The battery unit 120 may discharge alternating current (AC) power and supply it to the inverters 111a, 112a, and the inverters 111a, 112a may convert the AC power into the direct current (DC) power and supply it to the drive motor 111 and the PTO motor 112.

The drive cooling unit 130 performs a cooling process of supplying first cooling water cooled by air cooling through external air to the drive unit 110, and may form a cooling loop that circulates this cooling process. The drive cooling unit 130 may include a first heat exchanger 131 and a drive-side control valve 134.

The first heat exchanger 131 may cool the first cooling water supplied to the drive unit 110 by exchanging heat with external air, and an air-cooled radiator may be applied as an example.

The first cooling water that has exchanged heat with external air in the first heat exchanger 131 may be supplied to the drive unit 110 through the drive-side control valve 134.

At this time, the first cooling water heat-exchanged in the first heat exchanger 131 may be supplied to the drive-side control valve 134 via the reservoir tank 132 and the electric water pump (EWP) 133.

The drive-side control valve 134 may be, for example, a three-way valve, and may selectively supply the first cooling water cooled in the first heat exchanger 131 to the drive motor 111 and PTO motor 112 of the drive unit 110.

For example, the drive-side control valve 134 may supply the first cooling water to the drive motor 111 and the PTO motor 112 of the drive unit 110 under normal load conditions, and may block the first cooling water to the drive motor 111 of the drive unit 110 under concentrated high-load conditions and supply the first cooling water only to the PTO motor 112.

The first cooling water supplied to the drive motor 111 and PTO motor 112 through the drive-side control valve 134 and having performed cooling may be merged and circulated again to the first heat exchanger 131 through a cooling loop of the drive cooling unit 130.

At this time, the first cooling water that has completed cooling the drive motor 111 and PTO motor 112 may be supplied to the oil cooler 135 to cool the oil, thereby maintaining the temperature of the oil within the normal operating range.

The battery cooling unit 140 may perform a cooling process of supplying second cooling water cooled by water cooling through a heat exchange medium such as a refrigerant to the battery unit 120, and may form a cooling loop for circulating the cooling process. The battery cooling unit 140 may include a second heat exchanger 141.

The second heat exchanger 141 may cool the second cooling water supplied to the battery unit 120 by exchanging heat with a heat exchange medium such as a refrigerant. For example, a plate-type chiller may be applied as an evaporator constituting a refrigeration cycle.

That is, the second heat exchanger 141 is an evaporator of a refrigeration cycle including a compressor 142, a condenser 143 and an expansion valve 144, and may cool the second cooling water by receiving a low-temperature heat exchange medium such as a refrigerant through the refrigeration cycle.

At this time, the second cooling water heat-exchanged in the second heat exchanger 141 may be supplied to the battery unit 120 via the reservoir tank 145 and the electronic water pump 146.

The second cooling water supplied to the battery unit 120 through the electronic water pump 146 and having performed cooling, may be circulated back to the second heat exchanger 141 through the cooling loop of the battery cooling unit 140.

At this time, the second cooling water that has completed cooling of the battery unit 120 may be circulated to the second heat exchanger 141 via the water-heating positive temperature coefficient (PTC) heater 147. The second cooling water, whose temperature has risen due to cooling of the battery unit 120, passes through the water-heating PTC heater 147, thereby improving the heating efficiency of the water-heating PTC heater 147.

The bypass cooling unit 150 is arranged between the drive cooling unit 130 and the battery cooling unit 140, and may selectively exchange heat between a heat exchange medium, such as the refrigerant of the second heat exchanger 141, and the first cooling water of the drive cooling unit 130, and may supply the first cooling water, which has exchanged heat with the heat exchange medium, to the drive unit 110.

In some embodiments, the bypass cooling unit 150 may include a bypass heat exchanger 151 and a bypass control valve 152.

The bypass heat exchanger 151 may exchange heat with the first cooling water supplied to the PTO motor 112 of the drive unit 110 and a heat exchange medium, and may supply the first cooling water to the PTO motor 112.

That is, the bypass heat exchanger 151 exchanges heat between the first cooling water of the drive cooling unit 130 and a heat exchange medium of the second heat exchanger 141, and may supply the first cooling water to the PTO motor 112.

Ultimately, the bypass cooling unit 150 may rapidly and effectively cool the first cooling water and supply it to the PTO motor 112, and may enhance the cooling efficiency of the PTO motor 112 of the drive unit 110 even under specific operating conditions such as concentrated high-load operation of the PTO motor 112.

The bypass heat exchanger 151 may supply the heat exchange medium, which has exchanged heat with the first cooling water, to the compressor 142 that forms a refrigeration cycle together with the second heat exchanger 141, thereby allowing the medium to be recirculated.

The bypass control valve 152 may selectively supply heat exchange medium from the second heat exchanger 141 to the bypass heat exchanger 151.

The bypass control valve 152 may, for example, be a three-way valve, and may selectively supply the heat exchange medium, which has completed heat exchange with the second cooling water in the second heat exchanger 141, to the bypass heat exchanger 151.

For example, the bypass control valve 152 may block the supply of a heat exchange medium, such as a refrigerant that has completed heat exchange with the second cooling water in the second heat exchanger 141, to the bypass heat exchanger 151 under normal-load conditions, and may supply it to the bypass heat exchanger 151 under concentrated high-load conditions.

At this time, the cooling system 100 of the present embodiment may be configured to supply the first cooling water to the bypass heat exchanger 151 by bypassing the section where heat is exchanged with external air under concentrated high-load conditions.

In some embodiments, the drive cooling unit 130 may further include a drive-side bypass valve 136 and a bypass flow path 137, and may be configured, for example, to control the drive-side bypass valve 136 such that the first cooling water discharged from the drive unit 110 is not supplied to the first heat exchanger 131 but is supplied to the reservoir tank 132 through the bypass flow path 137.

The cooling system 100 of the present embodiment may be configured such that, under high-load operating conditions, the first cooling water supplied to the PTO motor 112 bypasses the first heat exchanger 131 and is rapidly and concentrically supplied to the bypass heat exchanger 151.

Accordingly, the first cooling water may exchange heat more rapidly with the heat exchange medium in the bypass heat exchanger 151, thereby improving the cooling efficiency of the PTO motor 112.

The control unit 160 may perform various controls, such as operation and power supply of components and devices constituting the cooling system 100 of the electric tractor according to the present embodiment. In particular, the control unit 160 may perform control of the drive cooling unit 130, the battery cooling unit 140, and the bypass cooling unit 150.

The control unit 160 may operate the drive cooling unit 130 on the basis of a current value generated during operation of the drive unit 110, thereby enabling rapid response to the heat load of thermal management targets such as the drive unit 110, reducing system load, and enhancing durability and performance of the thermal management targets.

For example, products such as a drive motor 111 and a PTO motor 112 may operate by receiving power from a battery unit 120, and the temperature of products such as a drive motor 111 and/or a PTO motor 112 may gradually rise during operation.

Products such as the drive motor 111 and the PTO motor 112 may generate a current value as the temperature rises, and the generated current value may increase in a constant proportion as the temperature rises.

Therefore, it is possible to accurately determine the temperature at which cooling of the drive motor 111 and the PTO motor 112 is required, and to set current values of the drive motor 111 and the PTO motor 112 corresponding to the temperature at which cooling is required.

And, the control unit 160 may start controlling the drive unit 110. That is, the control unit 160 may detect the current value generated during the operation of the drive motor 111 and PTO motor 112 in real time and start controlling the drive unit 110.

At this time, in case that the detected current value is equal to or greater than a preset current value, the control unit 160 may operate (ON) the cooling system 100 to cool products such as the drive motor 111 and PTO motor 112.

That is, in case that the current value generated from the drive motor 111 and the PTO motor 112 is equal to or greater than a preset current value, the control unit 160 may operate the drive cooling unit 130 to cool products such as the drive motor 111 and the PTO motor 112.

Meanwhile, the operation of the battery cooling unit 140 may also be controlled by the control unit 160 in a similar manner to the drive cooling unit 130.

That is, the control unit 160 may detect the current value generated during the discharge process in which a product such as the battery unit 120 supplies power, and in case that the detected current value is equal to or greater than a preset current value, the battery cooling unit 140 may be turned on to cool the product such as the battery unit 120.

In some embodiments, the bypass cooling unit 150 may be controlled by the control unit 160 to operate (ON) under specific driving conditions, such as concentrated high-load operation of the drive unit 110, particularly the PTO motor 112, along with the operation of the drive cooling unit 130 and the battery cooling unit 140.

Hereinafter, with reference to the attached drawings, the operation process according to the operating load of the cooling system 100 of an electric tractor according to an embodiment of the present disclosure will be described as follows.

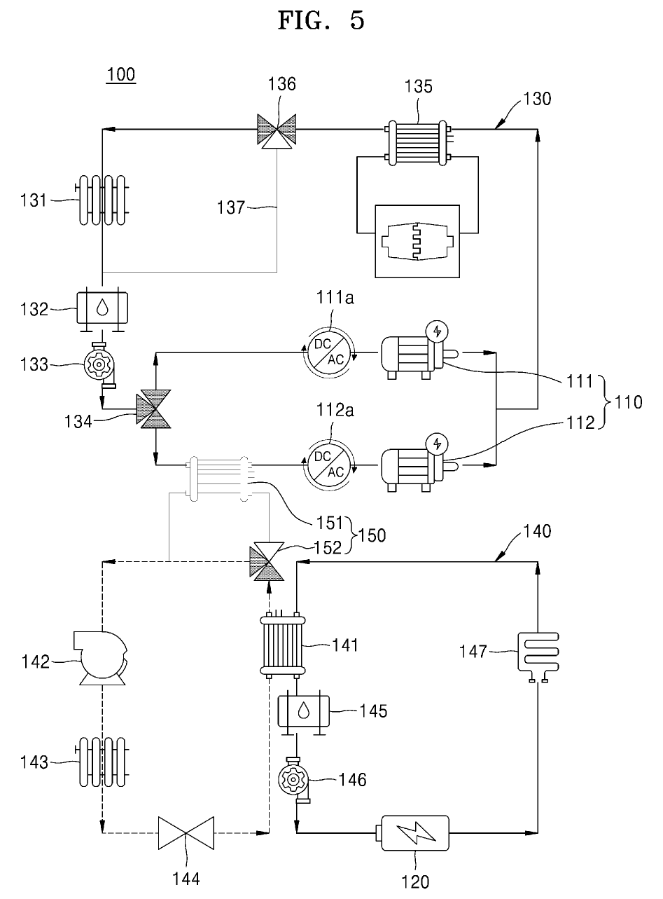

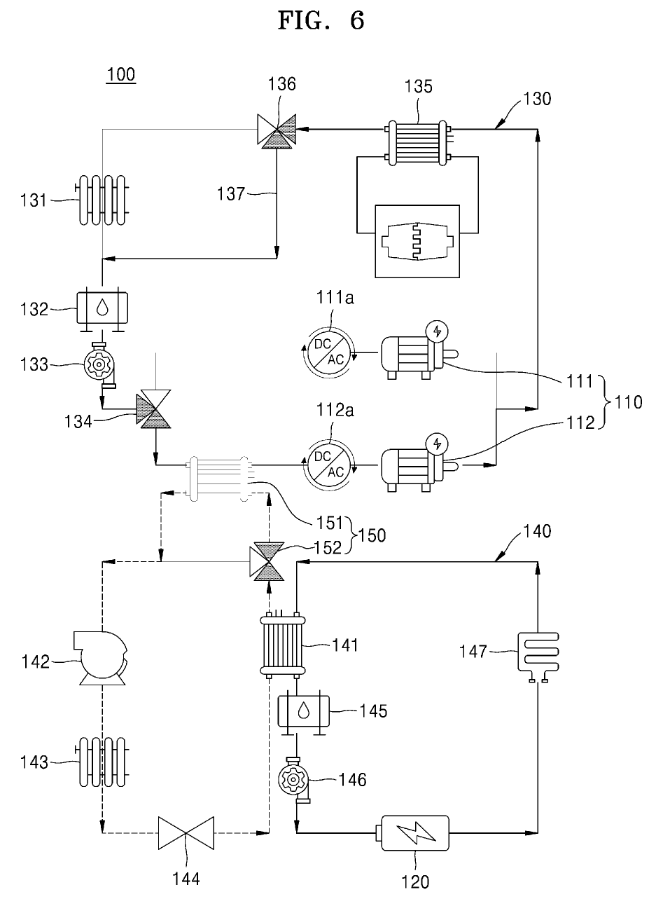

FIG. 5 is a schematic diagram illustrating a cooling system of an electric tractor according to an embodiment of the present disclosure during normal-load operation, and FIG. 6 is a schematic diagram illustrating a cooling system of an electric tractor according to an embodiment of the present disclosure during concentrated high-load operation.

First, referring to FIG. 5, the normal-load operation of the cooling system 100 according to the present embodiment may be an operation in which the drive motor 111 and the PTO motor 112 of the drive unit 110 are driven together, and may correspond particularly to a case where the PTO motor 112 is driven under a preset load or less.

During normal-load operation, only the drive cooling unit 130 and battery cooling unit 140 may be operated, excluding the bypass cooling unit 150.

That is, the bypass control valve 152 may block the heat exchange medium discharged from the second heat exchanger 141 from being supplied to the bypass heat exchanger 151 and may allow it to be supplied directly to the compressor 142.

In some embodiments, during normal-load operation, the drive motor 111 and PTO motor 112 of the drive unit 110 may be driven together, and the battery unit 120 may perform a discharge process to supply power to the drive unit 110.

Accordingly, the drive cooling unit 130 may be operated to cool the drive motor 111 and PTO motor 112 of the drive unit 110, and the battery cooling unit 140 may be operated to cool the battery unit 120.

The drive cooling unit 130 may cool the first cooling water with external air through the first heat exchanger 131 and supply the cooled first cooling water to the drive motor 111 and PTO motor 112 of the drive unit 110 to the drive unit to cool the same 110.

At this time, the first cooling water that has been heat-exchanged in the first heat exchanger 131 may be supplied to the drive unit 110 via the reservoir tank 132, the electric water pump (EWP) 133, and the drive-side control valve 134.

The first cooling water supplied to the drive unit 110 to perform cooling and discharged may be supplied to the oil cooler 135 to cool the oil.

The first cooling water passing through the oil cooler 135 may be circulated back to the first heat exchanger 131 through the cooling loop of the drive cooling unit 130.

The battery cooling unit 140 may cool the second cooling water using a heat exchange medium such as a refrigerant through the second heat exchanger 141 and supply the cooled second cooling water to the battery unit 120 to cool the battery unit 120.

At this time, the second cooling water, which has exchanged heat in the second heat exchanger 141, may be supplied to the battery unit 120 via the reservoir tank 145 and the electronic water pump 146.

In some embodiments, the second heat exchanger 141 is an evaporator of a refrigeration cycle including a compressor 142, a condenser 143, and an expansion valve 144, and may cool the second cooling water by receiving a low-temperature heat exchange medium such as a refrigerant through the refrigeration cycle.

The second cooling water supplied to the battery unit 120 to perform cooling and then discharged may pass through a water-heating positive temperature coefficient (PTC) heater 147 and circulate back to the second heat exchanger 141 through the cooling loop of the battery cooling unit 140.

Next, referring to FIG. 6, concentrated high-load operation of the cooling system 100 according to the present embodiment may be an operation in which only the PTO motor 112 of the drive unit 110 is driven, and may be particularly applicable to a case where the PTO motor 112 is intensively driven under a high load equal to or greater than a preset load.

During concentrated high-load operation, both the drive cooling unit 130 and the battery cooling unit 140 as well as the bypass cooling unit 150 may be operated.

In some embodiments, during concentrated high-load operation, the drive unit 110 may drive only the PTO motor 112 excluding the drive motor 111, and the battery unit 120 may perform a discharge process to supply power to the PTO motor 112.

Accordingly, the drive cooling unit 130 may be operated to cool the PTO motor 112 of the drive unit 110, the battery cooling unit 140 may be operated to cool the battery unit 120, and at the same time, the bypass cooling unit 150 may be operated.

That is, the bypass control valve 152 may block the heat exchange medium, such as refrigerant, discharged from the second heat exchanger 141 from being supplied to the compressor 142 and supply it directly to the bypass heat exchanger 151.

At this time, the first cooling water of the drive cooling unit 130 may exchange heat with a heat exchange medium in the bypass heat exchanger 151 and may be supplied to the PTO motor 112 of the drive unit 110.

That is, the bypass heat exchanger 151 may supply the first cooling water of the drive cooling unit 130 to the PTO motor 112 by exchanging heat with the heat exchange medium of the second heat exchanger 141.

As a result, the bypass cooling unit 150 may rapidly and effectively cool the first cooling water and supply it to the PTO motor 112, and may improve the cooling efficiency of the PTO motor 112 even under specific operating conditions such as concentrated high-load operation of the PTO motor 112 of the drive unit 110.

At this time, the bypass heat exchanger 151 may supply the heat exchange medium, which has exchanged heat with the first cooling water, to the compressor 142 that forms a refrigeration cycle together with the second heat exchanger 141, thereby enabling recirculation.

In some embodiments, under concentrated high-load conditions, the first cooling water may be supplied to the bypass heat exchanger 151 by bypassing a section where heat is exchanged with the external air.

In detail, by controlling the drive-side bypass valve 136, the first cooling water discharged from the PTO motor 112 of the drive unit 110 may be supplied directly to the reservoir tank 132 through the bypass flow path 137 without being supplied to the first heat exchanger 131.

That is, under concentrated high-load operating conditions, the first cooling water supplied to the PTO motor 112 may bypass the first heat exchanger 131 and be rapidly and intensively supplied to the bypass heat exchanger 151.

Accordingly, the first cooling water may be heat-exchanged with the heat exchange medium more rapidly in the bypass heat exchanger 151, thereby improving the cooling efficiency of the PTO motor 112.

According to the means for solving the above-described problems of the present disclosure, the cooling system of an electric tractor according to an embodiment of the present disclosure can improve the cooling efficiency of a PTO motor under specific operating conditions, such as concentrated high-load operation, with a simple structure.

In addition, the cooling system of an electric tractor according to an embodiment of the present disclosure can reduce the load of the cooling system by efficiently controlling the operation of the system, and can rapidly cool a thermal management target, thereby improving the durability and performance of the thermal management target.

Of course, the scope of the present disclosure is not limited by these effects.

Although the present disclosure has been described with reference to an embodiment illustrated in the drawings, this is merely exemplary, and those skilled in the art will understand that various modifications and variations of embodiments may be made therefrom. Therefore, the true technical protection scope of the present disclosure should be defined by the technical spirit of the attached patent claims.

What is claimed is:

1. A cooling system for an electric tractor, comprising:
a drive unit including a drive motor configured to generates drive power and a power take off (PTO) motor configured to generate working power;
a battery unit that supplies power to the drive unit;
a drive cooling unit that circulates a first cooling water to the drive unit and cools the same;
a battery cooling unit that circulates a second cooling water to the battery unit and cools the same;
a bypass cooling unit disposed between the drive cooling unit and the battery cooling unit, and configured to selectively exchange heat between the first cooling water and a heat exchange medium that has exchanged heat with the second cooling water, and to supply the first cooling water to the drive unit; and
a control unit configured to control operation of the drive cooling unit, the battery cooling unit, and the bypass cooling unit.

2. The cooling system of the electric tractor of claim 1,
wherein the drive cooling unit comprises
a first heat exchanger configured to exchange heat between the first cooling water and outside air and to supply the first cooling water to the drive unit.

3. The cooling system of the electric tractor of claim 2,
wherein the drive cooling unit further comprises
a drive-side control valve configured to supply the first cooling water, heat-exchanged in the first heat exchanger, to at least one of the drive motor and the PTO motor.

4. The cooling system of the electric tractor of claim 1,
wherein the battery cooling unit comprises
a second heat exchanger configured to exchange heat between the second cooling water and a heat exchange medium and to supply the second cooling water to the battery unit.

5. The cooling system of the electric tractor of claim 4,
wherein the second heat exchanger comprises an evaporator that constitutes a refrigeration cycle of the heat exchange medium.

6. The cooling system of the electric tractor of claim 1,
wherein the bypass cooling unit comprises
a bypass heat exchanger configured to exchange heat between the first cooling water supplied to the PTO motor and the heat exchange medium.

7. The cooling system of the electric tractor of claim 6,
wherein the bypass heat exchanger receives
a heat exchange medium from an evaporator constituting a refrigeration cycle of the heat exchange medium, exchanges heat with the first cooling water, and supplies the heat exchange medium that has exchanged heat with the first cooling water to a compressor constituting the refrigeration cycle.

8. The cooling system of the electric tractor of claim 7,
wherein the bypass cooling unit
further comprises a bypass control valve configured to selectively supply the heat exchange medium from the evaporator to the bypass heat exchanger.

9. The cooling system of the electric tractor of claim 1,
wherein, in case that the first cooling water is supplied only to the PTO motor by exchanging heat with a heat exchange medium through the bypass cooling unit, the first cooling water bypasses a section where the first cooling water exchanges heat with external air and is supplied to the bypass cooling unit.

10. The cooling system of the electric tractor of claim 1,
wherein the control unit controls the operation of the bypass cooling unit according to a current value generated during operation of the drive unit.
